(19) United States
(12) Patent Application Publication
(10) Pub. No.: US 2006/0290759 A1
(43) Pub. Date: Dec. 28, 2006

(54) Ink composition, ink cartridge to store the ink composition, and inkjet recording apparatus including the ink cartridge

(75) Inventors: Seung-min Ryu, Yongin-si (KR); Jong-in Lee, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd.

(21) Appl. No.: 11/450,368

(22) Filed: Jun. 12, 2006

(30) Foreign Application Priority Data
Jun. 24, 2005 (KR) 10-2005-0055125

(51) Int. Cl. G01D 11/00; C09D 11/00

(52) U.S. Cl. 347/100; 106/31.59; 106/31.89; 106/31.58; 106/31.86; 106/31.49; 106/31.78; 106/31.77; 106/31.47; 106/31.43; 106/31.75

(57) ABSTRACT

An ink composition including a colorant, a first surfactant including at least one of an ionic surfactant and a zwitter ionic surfactant, in an amount that is less than 150 parts by weight based on 100 parts by weight of the colorant, a second surfactant including a nonionic surfactant, in an amount that is less 20 times the amount of the first surfactant, and water; an ink cartridge including the same; and an inkjet recording apparatus including the ink cartridge. The ink composition can maintain a uniform and stable ink flow in an ink path of a print head of the cartridge by securing an optimum dynamic surface tension and minimizing generation of foam. Additionally, the ink composition can also provide uniform printing quality in continued printing and provide stability of long period of use and storage by preventing formation of missing dots due to prevention of the ink flow or occlusion of a nozzle by foam generated during the ink flow.

### CROSS-REFERENCE TO RELATED APPLICATIONS

This application claims the benefit of Korean Patent Application No. 2005-55125, filed on Jun. 24, 2005, in the Korean Intellectual Property Office, the disclosure of which is incorporated herein in its entirety by reference.

### BACKGROUND OF THE INVENTION

1. Field of the Invention

The present general inventive concept relates to an ink composition, and more particularly, to an ink composition that can maintain ink formation and ejection uniformly and stably through a uniform ink flow along an ink path in an ink cartridge by stabilizing a dynamic surface tension of the ink, and can also prevent non-uniform ink flow and occlusion of the ink path or a nozzle due to foam generated during the ink flow, an ink cartridge to store the ink composition, and an inkjet recording apparatus including the ink cartridge.

2. Description of the Related Art

An ink composition for inkjet printing generally includes various types of surfactants in order to control ink surface tension.

In an effort to prevent nozzle clogging and control the ink surface tension, Japanese Patent No. 63-165465 describes a technique where 0.5 to 25 wt % of a surfactant, such as sodium dodecyl benzenesulfonate, sodium laurate and polyethylene glycol monooleyl ether, is used in an ink composition. Additionally, U.S. Pat. No. 5,116,409 describes a technique where a zwitter ionic surfactant and a nonionic surfactant are used in more amounts than CMC concentration (Critical Micelle Concentration) to control bleeding between color inks made of dyes. U.S. Pat. No. 5,156,675 describes a technique where 0.01 to 5 w % of a polymer surfactant and an ancillary solvent are used to dry ink within 1 second by improving a drying property of the ink in general sheets.

When a large amount of the surfactant or the polymer surfactant is used, a shorter drying time can be obtained by controlling ink surface tension and improving simply infiltration of ink. However, a uniform ink flow in an ink path of a head chip and a cartridge cannot be maintained even for ink having similar surface tension. Also, foam is generated. That is, the foam can be generated in the ink during continued use of the ink or circulation of the ink from an ink tank to an ink cartridge, and thus it is difficult to remove the generated foam. Further, properties and performance of ink are not maintained in a stable state when environmental changes occur. For example, when the foam is generated due to a volumetric expansion of the ink due to a temperature change during long term storage, or when a speed of ink flow becomes non-uniform, dots are not formed uniformly in printing. As a result, many missing dots are formed.

### SUMMARY OF THE INVENTION

The present general inventive concept provides an ink composition that can maintain a stable and uniform ink flow in an ink path even during various environmental changes, thereby maintaining a size and shape of ejected ink droplets. Additionally, the ink composition further provides a desired number of printing dots, thereby enhancing an optical density and a resolution of an image, an ink cartridge including the same, and an inkjet recording apparatus including the ink cartridge.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an ink composition including a colorant, a first surfactant including at least one of an ionic surfactant and a zwitter ionic surfactant in an amount that is less than 150 parts by weight based on 100 parts by weight of the colorant, a second surfactant including a nonionic surfactant in an amount that is less 20 times the amount of the first surfactant, and water.

The foregoing and/or other aspects of the present general inventive concept are also achieved by providing an ink cartridge including the ink composition described above.

The foregoing and/or other aspects of the present general inventive concept are also achieved by providing an inkjet recording apparatus including the ink cartridge described above.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 illustrates a main drop and a satellite drop generated when an ink composition according to an embodiment of the present general inventive concept is ejected;

FIG. 2 is a perspective view illustrating an inkjet recording apparatus including an ink cartridge having an ink composition according to an embodiment of the present general inventive concept; and

FIG. 3 is a sectional view illustrating an ink cartridge having an ink composition according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

An ink composition according to an embodiment of the present general inventive concept includes a first surfactant having at least one of an ionic surfactant and a zwitter ionic surfactant, and a second surfactant having a nonionic surfactant.

An amount of the first surfactant is less than 150 parts by weight based on 100 parts by weight of a colorant, and particularly, 1 to 100 parts by weight. If the amount of the first surfactant exceeds 150 parts by weight, much foam is generated, thereby resulting in poor image quality.

An amount of the second surfactant is less than 20 times the amount of the first surfactant, and may be 1 to 15 times the amount of the first surfactant. If the amount of the second surfactant exceeds 20 times the amount of the first surfactant, wetting occurs at nozzle surfaces such that a desired ejection profile and speed cannot be maintained, and furthermore, colors can mix with one another due to a counter current of ink through respective nozzles.

Total amounts of the first surfactant and the second surfactant in the present embodiment may be 1 to 300 parts by weight based on 100 parts by weight of the colorant. If the total amounts of the first surfactant and the second surfactant exceed this range, an initial dynamic surface tension of the ink becomes so low that a speed of ink flow cannot be controlled, thereby failing to provide uniformity of ink ejection speed, and infiltration in general sheets may be substantial, thereby drastically decreasing image density. In other words, if the speed of the ink flow cannot be controlled, the ink ejected to a general sheet (e.g., paper) may have a tendency to spread out onto the paper, thereby reducing the image density.

When printing an area of 10×10 cm of a solid pattern in 50% coverage by employing the ink composition according to the present embodiment, a degree of missing dots does not exceed 20% of printing dots.

In general, ink for inkjet printing includes at least one surfactant to obtain a constant surface tension. Herein the surface tension obtained by the at least one surfactant is mostly “a static surface tension”, which refers to a surface tension of the ink between the surface of ink and air, when a specific amount of ink is placed in a container.

However, in an inkjet printer, the ink is not ejected in a static state from a chamber containing the ink, but is instead fed from an ink tank or ink cartridge to a head chip through an ink feeding channel. The ink should move (i.e., flow) among these components uniformly. Therefore, it is desirable to secure a dynamic surface tension having a specific value, rather than focusing on the static surface tension as done with conventional ink compositions.

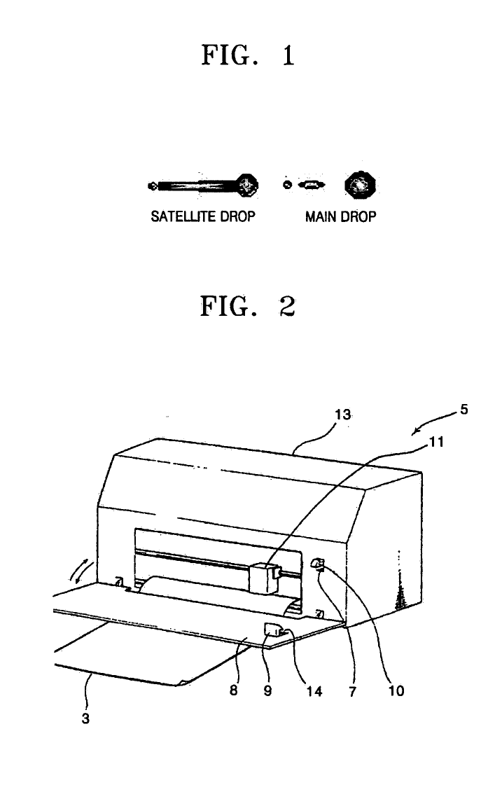

Recently, it has been considered that several picolitres (pl) to around ten pl of small droplets are ejected many times in order to increase an image resolution. Additionally, a number of nozzles that eject droplets simultaneously has increased or an array printing has been applied in order to increase a printing speed of the ink jet printer. In order to eject small droplets from the inkjet printer quickly and uniformly, a maximum dynamic surface tension should be below 50 dyne/cm, and the dynamic surface tension 1000 msec after ejection from the nozzles should be maintained below 40 dyne/cm. If the maximum dynamic surface tension exceeds 50 dyne/cm, the small droplets that are smaller than ten pi cannot be easily formed and ejected. Further, when the ink droplets are separated from the surface of the nozzle after being ejected from the head chip, a main drop and at least one small drop are formed as illustrated in FIG. 1. If several small drops formed from this procedure are not combined with the main drop, many satellite drops are formed. If the dynamic surface tension decreases below 25 dyne/cm 10 msec and 1000 msec after ejection from the nozzles, the number of satellite drops increases significantly such that an image quality cannot be maintained.

Accordingly, more than two surfactants can be used to obtain a value of the dynamic surface tension as described above.

Further, it is desirable to maintain uniformity of an ink flow in a complicated headcartridge structure. Also, if an ink foam is generated by an environmental change, an ink migration during the ink flow, or long-term use or storage of the ink, the foam prevents the ink droplets from being ejected and/or the nozzles in the head chip may be occluded. In this case, ejection of the ink droplets is either not performed or is not performed smoothly. Thus, the foam should be prevented. Accordingly, in order to prevent generation of the ink foam, a polymer defoamer including silicon or fluorine, or a sulfur compound having strong defoamability can be employed.

However, when the polymer defoamer is employed, the ink may get clogged in the ink chamber and/or the nozzles making the ink difficult to eject since the polymer defoamer and the ink have a poor compatibility. This may create a more severe problem in a fast printing system in which the ink droplets are smaller. Unlike the polymer defoamer, the sulfur compound has good compatibility with the ink, however, ink infiltration may be substantial in general sheets even when used in small amounts such that a large amount of ink spreading may occur, thereby decreasing image density. This may prevent a desired image quality from being obtained. Furthermore, when the sulfur compound is used, clogging due to quick drying of ink on the surface of the nozzle prevents the ink from being ejected. Also, the sulfur compound has an unpleasant odor depending on the type of compound being used in the ink composition.

Accordingly, in order to prevent nozzle occlusion due to foam by improving defoamability of ink without using the polymer defoamer or the sulfur compound, it is desirable to be able to identify the material causing the ink to foam and develop methods to prevent foaming of ink, accordingly.

The material causing foam in the ink is a surfactant. Therefore, a property and an amount of the surfactant may be properly controlled in order to obtain the defoamability of ink. More particularly, the amount of the nonionic surfactant (i.e., the second surfactant) may be controlled while a minimum amount of the first surfactant, which includes the at least one of the ionic surfactant or the zwitter ionic surfactant, is used in order to secure a desired dynamic surface tension. Accordingly, the respective amounts of surfactants that are used to obtain desired defoamability and the dynamic surface tension are the same as described above with respect to the first and second surfactants.

An ink composition according to the present embodiment can be used to properly eject ink, since the ink flow is uniform and stable even after a long period of use or storage. Accordingly, a degree to which missing dots are generated due to nozzle occlusion by generated foam or residual foam can be minimized, and a decrease in image resolution due to undesirable properties of ink droplets can be prevented.

The ionic surfactant according to the present embodiment includes at least one material selected from the group including a C1-C20 alkyl carboxylate, a C1-C20 alkyl sulfonic esterate, a C1-C20 alkyl sulfonate, a C1-C20 alkylbenzene sulfonate, a C1-C20 fatty acid amine salt, a quaternary ammonium salt, a sulfonium salt and a phosphonium salt. A specific example of the ionic surfactant includes sodium dodecyl sulfate (SDS).

The zwitter ionic surfactant includes a C1-C20 alkylamine sulfonate, a C1-C20 alkylamine carboxylate, or a C1-C20 alkylamine phosphonium salt. A specific example of the zwitter ionic surfactant is N,N-dimethylodecylamine N-oxide.

The nonionic surfactant for the ink composition according to the present embodiment can be polyoxyethylene alkyl ether, polyoxyethylene alkyl phenyl ether, polyoxyethylene secondary alcohol ether, polyoxyethylene-oxypropylene block copolymer, polyglycerine fatty acid ester, sorbitan monoester alkoxylate, acetylenic polyalkylene oxide, acetylenic diol and etc. An example of the nonionic surfactant is surfynol 465 (Air Product). Another example is surfynol 104 (Air Product).

An amount of water in the ink composition according to the present embodiment may be 100 to 3,000 parts by weight based on 100 parts by weight of the colorant. In other words, at least the same amount of water is present in the ink composition with respect to the colorant. The amount of water by weight may be up to 30 times the amount of the colorant in the ink composition. If the amount of water in the ink composition is less than 100 parts by weight, a density of the colorant in the ink composition is too high such that a viscosity of the ink may also become high. If the amount of water exceeds 3,000 parts by weight, the amount of the colorant is very small such that a color of the ink may not be expressed easily.

An organic solvent may be used in the ink composition of the present embodiment, and may include a co-solvent. The ink composition may further include an amide-based compound, or a mixture of the organic solvent and the amide-based compound. A total amount of the organic solvent is 50 to 2000 parts by weight based on 100 parts by weight of the colorant. If the amount of the organic solvent is less than 50 parts by weight, it is difficult to provide a wetting effect and storage stability of the ink. If the amount of the organic solvent exceeds 2,000 parts by weight, the viscosity of the ink increases and a particle size of the ink also suddenly increases.

The co-solvent, which may be used in the ink composition of the present embodiment, may be, but is not limited to, an alcohol compound such as methyl alcohol, ethyl alcohol, n-propyl alcohol, isopropyl alcohol, n-butyl alcohol, sec-butyl alcohol, t-butyl alcohol or isobutyl alcohol; a polyhydric alcohol compound such as 1,6-hexanediol, 1,2-hexanediol, ethylene glycol, diethylene glycol, triethylene glycol, propylene glycol, butylene glycol, 1,4-butanediol, 1,2,4-butanetriol, 1,5-pentanediol, 1,2,6-hexanetriol, trimethanol propane, hexylene glycol, glycerol or poly(ethylene glycol); a ketone compound such as acetone, methylethyl ketone or diacetone alcohol; an ester compound such as ethyl acetate or ethyl lactate; a lower alkyl ether compound such as ethylene glycol monomethyl ether, ethylene glycol monoethyl ether, diethylene glycol methyl ether, diethylene glycol ethyl ether, diethylene glycol monobutyl ether, diethylene glycol diethyl ether, triethylene glycol monomethyl ether or triethylene glycol monoethyl ether; a sulfur-containing compound selected from the group including dimethyl sulfoxide, tetramethylene sulfone and thioglycol; or mixtures thereof.

The amide-based compound used in the ink composition of the present embodiment may be at least one compound selected from a group consisting of 2-pyrrolidone, 2-piperidone, N-methyl-pyrrolidone, caprolactam, tetrahydro-2-pyrimidone, 3-methyl-tetrahydro-2-pyrimidone, 2-imidazolidinone, dimethyl imidazolidinone, diethyl imidazolidinone, butyl urea, 1,3-dimethyl urea, ethyl urea, propyl urea, isopropyl urea and 1,3-diethyl urea.

If the co-solvent and the amide-based compound are used together with the organic solvent in an embodiment of the present general inventive concept, an amount of the amide-based compound is 5 to 80 parts by weight based on 100 parts by weight of the organic solvent.

The ink composition according to the present embodiment can further include additives such as a viscosity controller.

The colorant used in the present embodiment may be a self-dispersible pigment, or a conventional dye or pigment used with a dispersant.

The colorant may include, for example, but is not limited to, C.I. Basic Black 2, C.I. Direct Yellow 44, C.I. Basic Blue 26, or C.I. Direct Red 227.

The ink composition according to the present embodiment can further include an acid or a base to increase a solubility of a solvent against a humectant and to stabilize a pigment.

The ink composition according to the present embodiment obtained from the above combinations of compounds and/or materials has 15 to 70 dyne/cm of surface tension at 20° C., and 1.0 to 20 Cp (centi-poise) of viscosity. Further, the ink composition according to the present embodiment has a quick drying time of 0.05 to 3 seconds, particularly 0.1 to 1 second, for a general sheet (e.g., paper).

The ink composition of the present embodiment can be used in a toner composition, various paints, a coating liquid, etc. The ink composition may be also used in an inkjet printer cartridge including a nozzle array head having nozzles to eject the ink composition.

A throughput of the inkjet printer or an image forming apparatus can be increased, since the nozzle array head thereof prints with high speed by employing a plurality of head chips, unlike a shuttle-type inkjet printer that prints an image by transferring one head chip. However, the ink composition of the present embodiment may also be used with the shuttle-type inkjet printer.

FIG. 2 is a perspective view illustrating an inkjet recording apparatus 5 including an ink cartridge 11 having an ink composition according to an embodiment of the present general inventive concept.

Referring to FIG. 2, the inkjet recording apparatus 5 includes the ink cartridge 11 including the ink composition. The ink composition contained in the ink cartridge 11 may be similar to the ink composition described above in previous embodiments. A printer cover 8 is connected with a main body 13 of the inkjet recording apparatus 5. A region of a moving latch 10 protrudes through a hole 7 in the main body 13. The moving latch 10 is engaged with a fixed latch 9, and the fixed latch 9 is connected to an inside of the printer cover 8 when the printer cover 8 is closed. The printer cover 8 has a recess 14 that corresponds to the region of the moving latch 10 protruding through the hole 7. The ink cartridge 11 is mounted in the main body 13 and ink is ejected on a piece of paper 3 (or other recording medium) that is transferred under a lower part of the ink cartridge 11.

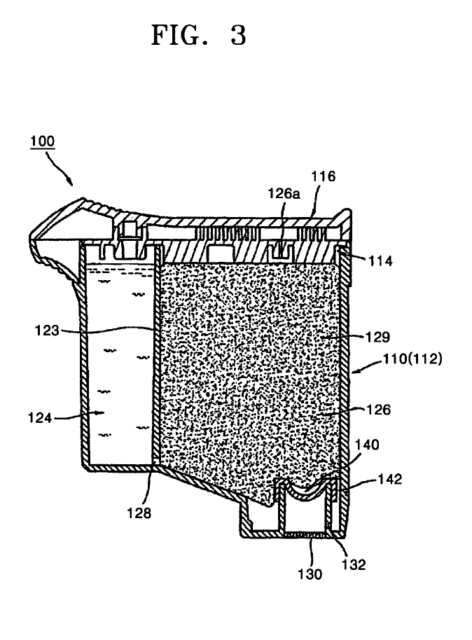

FIG. 3 is a sectional view illustrating an ink cartridge 100 including an ink composition according to an embodiment of the present general inventive concept. The ink cartridge 100 may be similar to the ink cartridge 11 of FIG. 2 and may contain the ink composition described in previous embodiments. The ink cartridge 100 includes a main body 110 forming an ink receiver 112, an inner cover 114 to cover a top region of the ink receiver 112, and an outer cover 116 spaced apart from the inner cover 114 by a predetermined interval to seal the ink receiver 112 and the inner cover 114.

The ink receiver 112 is divided into a first chamber 124 and a second chamber 126 by a vertical barrier wall 123. An ink passage 128 is formed at a lower part of the vertical barrier wall 123 between the first chamber 124 and the second chamber 126. The ink is filled into the first chamber 124 and a sponge 129, and then the second chamber 126. A vent hole 126a corresponding to the second chamber 126 is formed in the inner cover 114.

A filter 140 to prevent an ejection hole of a printer head 130 from clogging is formed in a lower part of the second chamber 126 to filter impurities and minute bubbles. A hook 142 is formed in an edge region of the filter 140 and is coupled to a top region of a standpipe 132. The ink in the ink receiver 112 passes through the ejection hole of the printer head 130 and is ejected as small droplets on a printing or recording medium (e.g., paper or a general sheet).

The printer head 130 may include, for example, an array head that uses more than 10,000 nozzles. The printer head 130 may be a line type print head that has a length that corresponds to a width of the printing medium such that entire lines of print data can be printed at each ink ejection time.

The embodiments of the present general inventive concept will be described in greater detail with reference to the following examples. The following examples are for illustrative purposes only and are not intended to limit the scope of the general inventive concept.

### EXAMPLES

Material used in the following examples is as follows.

<Colorants>
Black 1: Raven 5250, manufactured by Columbian Co.,
Black 2: Regal 330, manufactured by Cabot Co.,
Cyan 1: Direct Turquoise Blue, manufactured by Clariant,
Cyan 2: Direct Blue 199, manufactured by Hodogaya,
Magenta 1: Basacid Rot 495, manufactured by BASF,
Magenta 2: Acid Red 52, manufactured by Hodogaya,
Yellow 1: Yellow GGN, manufactured by Spectra, and
Yellow 2: Basacid Yellow 099, manufactured by BASF.

<Organic Solvents>
EG: Ethylene Glycol
DEG: Diethylene Glycol
Gly: Glycerine
1,2,6-hex: 1,2,6-hexanetriol
DEGMBE: Diethyleneglycol Monobutyl Ether

<Amide Compounds>
2-P: 2-pyrrolidone
NMP: N-methyl-2-pyrrolidone
Cyclo-P: Cyclohexyl pyrrolidone
C-lactam: Caprolactam
V-lactam: Valerolactam.

<Surfactants>
Surfactant 1 (ionic surfactant): Sodium dicyclohexyl sulfosuccinate manufactured by CTEC
Surfactant 2 (ionic surfactant): Sodium dicyclohexyl sulfosuccinate manufactured Aldrich
Surfactant 3 (zwitter ionic surfactant): N,N-dimethylodecylamine N-oxide manufactured by Aldrich
Surfactant 4 (zwitter ionic surfactant): N,N-dimethyl-N-octadecyl amine oxide manufactured by Aldrich
Surfactant 5 (nonionic surfactant): Tergitol manufactured by ICI
Surfactant 6 (nonionic surfactant): Surfynol 465 manufactured by Air Product
Surfactant 7 (nonionic surfactant): Pluronics manufactured by BASF
Surfactant 8 (nonionic surfactant): Tritons manufactured by Rohm & Haas.

Ink compositions can be prepared by employing the following colorants and the organic solvents.

In a number of experiments, each organic solvent was added to a 250 mil (milli litre) beaker to obtain ink compositions according to the ink compositions in Table 1 (below), and water was added thereto in order to obtain a total ink composition amount of 100 g. Then, the mixture was stirred in a stirrer operated at 700 rpm to until the mixture reached a homogeneous state. Finally, the mixture was filtered through 0.45 um (micrometer)filter to obtain a final ink composition. In Table 1 below, values in parenthesis following a corresponding ingredient indicate an amount of the ingredient with respect to other ingredient amounts. For example, the ink composition of Example 1 contains Black 1 in an amount that is 10 times an amount of surfactant 5 (i.e., the second surfactant) contained therein.

TABLE 1

| Sample | Colorant | Organic solvent (pbw) |
|---|---|---|
| Example 1 | Black 1 (4) | EG (8), DEG (6), Surfactant 1 (0.04), |
| | | Surfactant 5 (0.4) |
| Example 2 | Cyan 1 (4) | Gly (10), DEGMBE (8), NMP (5), Surfactant 3 |
| | | (0.1), Surfactant 6 (0.5) |
| Example 3 | Magenta 1 | 1,2,6-Hex(10), Cyclo-P (8), Surfactant 2 (0.4), |
| | (4) | Surfactant 7 (0.8) |
| Example 4 | Yellow 1 | Gly (10), DEG (6), V-lactam (4), Surfactant 4 |
| | (5) | (0.01), Surfactant 8 (0.15) |
| Example 5 | Black 2 (4) | EG (6), 2-P (5), Surfactant 5 (0.5), Surfactant |
| | | 3 (0.2), Surfactant 7 (0.8) |
| Example 6 | Cyan 2 (4) | Gly (10), DEGMBE (2), NMP (7), |
| | | Surfactant 2 (0.8), Surfactant 5 (0.8) |
| Example 7 | Magenta 2 | 1,2,6-Hex(10), DEG (6), Cyclo-P (6), |
| | (4) | Surfactant 4 (0.2), Surfactant 6 (0.6) |
| Example 8 | Yellow 2 | Gly (12), C-lactam (4), Surfactant 1 (0.02), |
| | (5) | Surfactant 8 (0.24) |
| Comp. | Black 1 (4) | EG (8), DEG (6), Surfactant 1 (0.05), |
| Example 1 | | Surfactant 5 (1.3) |
| Comp. | Cyan 1 (3) | 1,2,6-Hex(10), DEG (6), Surfactant 3 (0.9) |
| Example 2 | | |
| Comp. | Magenta 1 | Gly (10), DEG (6), V-lactam (4), Surfactant 2 |
| Example 3 | (4) | (1.2), Surfactant 6 (0.06) |
| Comp. | Yellow 1 | Gly (10), DEGMBE (8), NMP (5), Surfactant 4 |
| Example 4 | (5) | (0.8), Surfactant 1 (0.6) |
| Comp. | Black 2 (4) | 1,2,6-Hex (10), Cyclo-P (8), Surfactant 8 (1.2) |
| Example 5 | | |
| Comp. | Cyan 2 (3) | 1,2,6-Hex (10), DEG (6), Surfactant 1 (1.0), |
| Example 6 | | Surfactant 6 (0.03) |
| Comp. | Magenta 2 | Gly (10), DEG (6), V-lactam (4), Surfactant 5 |
| Example 7 | (4) | (0.8) |
| Comp. | Yellow 2 | Gly (10), DEGMBE (8), NMP (5), Surfactant 3 |
| Example 8 | (5) | (0.03), Surfactant 7 (0.7) |

### Experimental Example 1

### Test for Dynamic Surface Tension

Surface tension values of the ink compositions obtained in Examples 1-8 and Comparative Examples 1-8 were measured at 10 msec and 1000 msec after ejection from the nozzles by employing a Bubble Pressure Tensiometer-BP2 instrument (Kruss Company), and the results are shown in Table 2 below.

### Experimental Example 2

### Test for Defoamability

Three mls (milliliters) of the ink compositions obtained in Examples 1-8 and Comparative Examples 1-8 were placed in a 10 ml mess cylinder. The cylinder was capped. Then, the cylinder was violently shaken 20 times up and down. The volume of the resulting foam was then compared with that of an initial volume of the ink composition (i.e., 10 ml) in percentage. The results are shown in Table 2, below.
A=(resulting volume of ink composition minus (−) initial volume of ink composition/the initial volume of ink composition)×100(%)

⊚: A<20

O: 20≦A<50

X: 50≦A≦80

XX: A>80

### Experimental Example 3

### Test for Missing Dots

A degree of missing dots for the ink compositions obtained in Examples 1-8 and Comparative Examples 1-8 were evaluated when a 10×10 cm area of a solid pattern was printed in 50% coverage using a Samsung ink cartridge. The results are shown in Table 2, below.
B=(missing dots/total dots)×100(%)

⊚: B<10

O: 10≦B<20

X: 20≦B≦30

XX: B>30

### Experimental Example 4

### Test for Storage Stability of the Ink Cartridge

The ink compositions obtained in Examples 1-8 and Comparative Examples 1-8 were filled in a Samsung ink cartridge at an ambient temperature (25° C.) and a low temperature (−5° C.). Printing was then performed after 2 weeks, respectively, to determine how many nozzles were occluded. The results are shown in Table 2, below.

⊚: nozzle occlusion below 5% of existing nozzles was observed

O: nozzle occlusion at 6˜10% of existing nozzles was observed

X: nozzle occlusion at 11˜20% of existing nozzles was observed

XX: nozzle occlusion at more than 21% of existing nozzles was observed

### Experimental Example 5

### Test for Dryness

The ink compositions obtained in Examples 1-8 and Comparative Examples 1-8 were refilled in an ink cartridge M-50 (Samsung Electronics Co., Ltd.). Then, immediately after a bar picture (3*20 cm) was printed in a printer (MJC-3300P, Samsung Electronics Co., Ltd.), the sheet was put on the printed face and were passed through a press roll tester. An optical density (OD) value of the image that was then transferred from the bar picture was then compared to that of the image after the sheet passed through the press roll tester. The results in percentage are shown in Table 2 below.
A=(OD of transferred image/OD of original bar picture)×100(%)

⊚: A<15

O: 15≦A<30

X: 30≦A≦45

XX: A>45

TABLE 2

| | Difference in dynamic | | | | | |
|---|---|---|---|---|---|---|
| | surface tension | | | | | |
| | (dyne/cm) | | defoam- | Missing | Storage | dry- |
| | 10 ms | 1000 ms | ability | dot | stability | ness |
| Example 1 | 37.5 | 32.1 | ◯ | ⊚ | ⊚ | ⊚ |
| Example 2 | 43.2 | 36.4 | ⊚ | ◯ | ⊚ | ⊚ |
| Example 3 | 32.5 | 27.5 | ◯ | ⊚ | ⊚ | ⊚ |
| Example 4 | 48.9 | 41.3 | ⊚ | ◯ | ⊚ | ◯ |
| Example 5 | 31.2 | 26.5 | ◯ | ⊚ | ⊚ | ⊚ |
| Example 6 | 30.4 | 25.1 | ◯ | ⊚ | ⊚ | ⊚ |
| Example 7 | 40.5 | 34.7 | ⊚ | ◯ | ⊚ | ◯ |
| Example 8 | 47.3 | 41.2 | ⊚ | ⊚ | ⊚ | ◯ |
| Comp. | 31.4 | 24.9 | XX | X | X | ◯ |
| Example 1 | | | | | | |
| Comp. | 28.3 | 22.6 | XX | X | X | ◯ |
| Example 2 | | | | | | |
| Comp. | 25.3 | 20.8 | XX | X | XX | ◯ |
| Example 3 | | | | | | |
| Comp. | 27.2 | 21.4 | XX | X | XX | ◯ |
| Example 4 | | | | | | |
| Comp. | 52.3 | 47.2 | ◯ | X | XX | XX |
| Example 5 | | | | | | |
| Comp. | 50.4 | 45.1 | ◯ | X | X | XX |
| Example 6 | | | | | | |
| Comp. | 45.1 | 40.7 | ◯ | ◯ | XX | XX |
| Example 7 | | | | | | |
| Comp. | 48.1 | 42.3 | ◯ | X | X | XX |
| Example 8 | | | | | | |

The ink composition according to various embodiments of the present general inventive concept can maintain an ink flow stably and uniformly in an ink path even when various environmental changes occur. For example, during long term use or storage of ink, when there is a change of temperature resulting from long distance transportation of an ink cartridge containing the ink composition or when there is a circulation of ink using a separate ink tank, the embodiments of the present general inventive concept are able to maintain a size and shape of ejected ink droplets and provide desired printing dots. Accordingly, an optical density and resolution of an image can be enhanced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink composition, comprising:
a colorant;
a first surfactant including at least one of an ionic surfactant and a zwitter ionic surfactant in an amount that is less than 150 parts by weight based on 100 parts by weight of the colorant;
a second surfactant including a nonionic surfactant in an amount that is less 20 times the amount of the first surfactant; and
water.

2. The ink composition of claim 1, wherein total amounts of the first surfactant and the second surfactant are 1 to 300 parts by weight based on 100 parts by weight of the colorant.

3. The ink composition of claim 1, wherein the ionic surfactant is at least one of a C1-C20 alkyl carboxylate, a C1-C20 alkyl sulfonic esterate, a C1-C20 alkyl sulfonate, a C1-C20 alkylbenzene sulfonate, a C1-C20 fatty acid amine salt, a quaternary ammonium salt, a sulfonium salt and a phosphonium salt, and the zwitter ionic surfactant is a C1-C20 alkylamine sulfonate, a C1-C20 alkylamine carboxylate or a C1-C20 alkylamine phosphonium salt.

4. The ink composition of claim 1, wherein the nonionic surfactant is at least one of polyoxyethylene alkyl ether, polyoxyethylene alkyl phenyl ether, polyoxyethylene secondary alcohol ether, polyoxyethylene-oxypropylene block copolymer, polyglycerine fatty acid ester, sorbitan monoester alkoxylate, acetylenic polyalkylene oxide and acetylenic diol.

5. The ink composition of claim 1, wherein the colorant is one of a pigment, a dye, and a self-dispersible pigment.

6. The ink composition of claim 1, further comprising:
an organic solvent.

7. The ink composition of claim 6, wherein the organic solvent comprises:
at least one alcohol compound selected from the group consisting of methyl alcohol, ethyl alcohol, n-propyl alcohol, isopropyl alcohol, n-butyl alcohol, sec-butyl alcohol, t-butyl alcohol and isobutyl alcohol;
at least one polyhydric alcohol compound selected from the group consisting of 1,6-hexanediol, 1,2-hexanediol, ethylene glycol, diethylene glycol, triethylene glycol, propylene glycol, butylene glycol, 1,4-butanediol, 1,2,4-butanetriol, 1,5-pentanediol, 1,2,6-hexanetriol, trimethanol propane, hexylene glycol, glycerol and poly(ethylene glycol);
at least one ketone selected from the group consisting of acetone, methylethyl ketone and diacetone alcohol;
at least one ester compound selected from ethyl acetate and ethyl lactate;
at least one lower alkyl ether selected from the group consisting of ethylene glycol monomethyl ether, ethylene glycol monoethyl ether, diethylene glycol methyl ether, diethylene glycol ethyl ether, diethylene glycol monobutyl ether, diethylene glycol diethyl ether, triethylene glycol monomethyl ether and triethylene glycol monoethyl ether; or
at least one sulfur-containing compound selected from the group consisting of dimethyl sulfoxide, tetramethylene sulfone and thioglycol.

8. The ink composition of claim 6, wherein the organic solvent comprises at least one compound selected from the group including 2-pyrrolidone, 2-piperidone, N-methyl-pyrrolidone, caprolactam, tetrahydro-2-pyrimidone, 3-methyl-tetrahydro-2-pyrimidone, 2-imidazolidinone, dimethyl imidazolidinone, diethyl imidazolidinone, butyl urea, 1,3-dimethyl urea, ethyl urea, propyl urea, isopropyl urea and 1,3-diethyl urea.

9. The ink composition of claim 6, wherein an amount of the organic solvent is 100 to 2000 parts by weight based on 100 parts by weight of the colorant.

10. The ink composition of claim 1, wherein an amount of water is 100 to 3000 parts by weight based on 100 parts by weight of the colorant.

11. The ink composition of claim 1, wherein a surface tension of the ink composition is 15 to 70 dyne/cm, and a viscosity of the ink composition is 1 to 20 Cp (centra Poise), at 20 degrees Celsius.

12. The ink composition of claim 1, wherein the ionic surfactant comprises one of sodium dodecyl sulfate (SDS) and N,N-dimethylodecylamine N-oxide.

13. The ink composition of claim 1, wherein the nonionic surfactant comprises surfynol 465.

14. The ink composition of claim 1, wherein the water is between 100 to 3000 parts by weight based on 100 parts of the colorant.

15. The ink composition of claim 1, wherein the ionic surfactant comprises 1 to 150 parts by weight based on 100 parts of the colorant.

16. The ink composition of claim 1, wherein an amount of the non-ionic surfactant comprises 1 to 15 times an amount of the ionic surfactant.

17. The ink composition of claim 1, further comprising:
an organic solvent in an amount of 50 to 2000 parts by weight based on 100 parts of the colorant.

18. The ink composition of claim 17, further comprising:
an amide compound in an amount of 10 to 5000 parts by weight based on 100 parts of the organic solvent.

19. An ink cartridge, comprising:
an ink composition including:
a colorant,
a first surfactant including at least one of an ionic surfactant and a zwitter ionic surfactant in an amount that is less than 150 parts by weight based on 100 parts by weight of the colorant,
a second surfactant including a nonionic surfactant in an amount that is less 20 times the amount of the first surfactant, and
water.

20. An inkjet recording apparatus, comprising:
an ink cartridge having an ink composition disposed therein, the composition including:
a colorant,
a first surfactant including at least one of an ionic surfactant and a zwitter ionic surfactant in an amount that is less than 150 parts by weight based on 100 parts by weight of the colorant,
a second surfactant including a nonionic surfactant in an amount that is less 20 times the amount of the first surfactant, and
water.

21. The inkjet recording apparatus of claim 20, wherein the inkjet recording apparatus comprises an inkjet printer including an array head having more than 10,000 nozzles to eject the ink composition.

22. The inkjet recording apparatus of claim 20, further comprising:
a printer head disposed on a bottom surface of the ink cartridge and having a length that extends across a width of a sheet of recording medium.
